(19) United States
(12) Patent Application Publication
(10) Pub. No.: US 2007/0000284 A1
(43) Pub. Date: Jan. 4, 2007

(54) Perforated metal jewelry

(76) Inventors: David Rosenwasser, Englewood Cliffs, NJ (US); Avraham Rosenwasser, Englewood Cliffs, NJ (US)

Correspondence Address: KATTEN MUCHIN ROSENMAN LLP, 575 MADISON AVENUE, NEW YORK, NY, 10022-2585, US

(21) Appl. No.: 11/436,380

(22) Filed: May 18, 2006

Related U.S. Application Data
(60) Provisional application No. 60/686,788, filed on Jun. 1, 2005.

(51) Int. Cl. B23K 26/38; A44C 17/00

(52) U.S. Cl. 63/32; 219/121.69

(57) ABSTRACT

An article of jewelry is configured from a flat sheet of material provided with a pattern of perforations prior to bending the flat sheet into the desired shape of the article of jewelry.

### CROSS-REFERENCE TO RELATED APPLICATION This application claims priority to U.S. Provisional Application Ser. No. 60/686,788 filed on Jun. 1, 2005 and fully incorporated herein by reference.

### BACKGROUND OF THE INVENTION

1. Field of the Invention

This invention relates to articles of jewelry and more particularly such articles being formed from precious metals have perforations, and a method for forming such perforated precious metals.

2. Prior Art

Many articles of jewelry are made from sheet material which is rolled, pressed, or in some other way formatted into a particular article of jewelry. By way of example, bangle bracelets, and the like, are initially formed from a strip of precious metal such as gold. The gold is then formed into an arcuate cross section and bent around to form a circle to fit around the wrist. In some cases, the inner ends facing the wrist are left as a curved bead or in some cases the bottom portion facing the wrist will also be made of precious metal as the metal is bent to form a closed semicircle in cross section.

Other articles of jewelry such as the San Marco bracelet, or the Omega chain are each made of arcuate loops of metal which are initially formed from a flat sheet. The sheet is then bent into a curved section, typically with the bottom closed off with a piece of flat metal.

After the formation of such bangle bracelet, rings, or other portion of material that has been formed by bending the sheet material, decorations can be formed on the exterior surface. This can be through various well known formation techniques such as forming a pattern of perforations, changing the color, striating, etc.

Decorating bracelets, rings and other articles of jewelry with a pattern of perforations after shaping material into the desired form is time consuming. Also, the weight of many jewelry articles made from solid metals and particularly precious metals may be quite substantial. Besides, the use of solid areas of material in one or more interior portions of an article of jewelry may render the latter cost ineffective.

A need, therefore, exists for a time- and cost-effective method of making an article of jewelry provided with a pattern of perforations.

Another need exists for a method of making an article of jewelry that has practically a limitless number of patterns of decorative perforations.

A further need exist for an article of jewelry that has a pattern of perforations provided in a sheet of material prior to shaping the sheet into the article of jewelry.

### SUMMARY OF THE INVENTION

The present invention meets these needs and seeks to provide an initial sheet of material that is perforated. Such perforated sheet of material, which preferably is made of precious metals, can then be used in the same manner as in the prior art to bend it, shape it, etc. into the formation of bangle bracelets, Omega chains, San Marco, rings, earrings, or the like. Wherever such solid plate material was heretofore used, the perforated material of the present invention can be utilized.

The benefits of utilizing the perforated material are numerous. Firstly, because of the perforations which remove some of the precious material, the weight of the precious metal is substantially reduced. Therefore, in areas that are not readily visible, such as the underside of rings and bangle bracelets, through the use of the perforated metal rather than the solid metal, substantial cost savings can be made.

Furthermore, another benefit is that an initial design or aesthetic appearance can be formed into the perforated material before it is made to thereby provide an exterior aesthetic appearance on the particular article of jewelry by pre-forming it with the perforations rather than by forming the aesthetic appearance after the product has been formed.

The method of producing the perforations is done by punching either along a horizontal line of a punching process or passing the sheet material through a set of rollers. The particular shape, design, size of perforations, etc. can all be selected as desired.

The above and other features and advantages of the invention will hereinafter be explained in detail in conjunction with the following drawings.

### BRIEF DESCRIPTION OF THE DRAWINGS

FIG. 1 is perspective view of a bangle bracelet having beads at its edges;

FIG. 2 is a cross-sectional area taken along line 2—2 of FIG. 1 and illustrating a pattern of perforations that is formed in accordance with the invention;

FIG. 3 is a perspective view of a bangle bracelet;

FIG. 4 is a cross-sectional view taken along lines 4—4 of FIG. 3 and illustrating a pattern of perforations formed in accordance with the invention;

FIG. 5 is a section of a San Marco bracelet;

FIG. 6 is a cross-sectional view taken along lines 6—6 of FIG. 5 and illustrating the perforated parts of the inventive San Marco bracelet;

FIG. 7 is a perspective schematic view of a punching process used to form the perforations in accordance with the present invention;

FIG. 8 is a schematic elevational view of a roller process utilized in the formation of the perforations in accordance with the present invention;

FIGS. 9-18 show sections of various designs of perforated precious metals in accordance with the present invention;

FIG. 19 is a schematic view showing a precious sheet of metal on which only portions thereof have been perforated.

### DESCRIPTION OF PREFERRED EMBODIMENTS

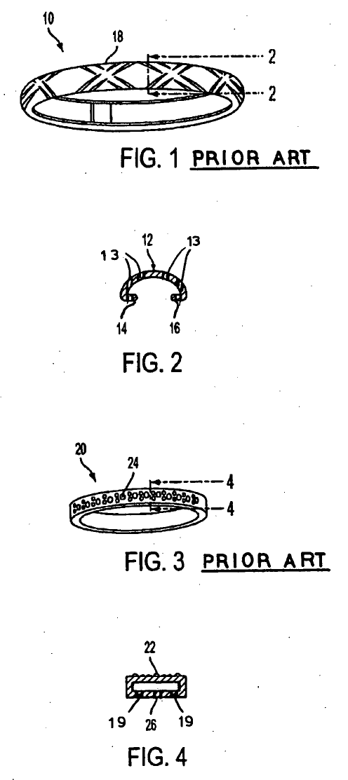

With reference to FIGS. 1 and 2, there is shown a standard type of bangle bracelet 10. The bracelet is typically formed of a sheet of solid material 12, which is arcuately curved, as shown in FIG. 2, with the interior ends thereof, 14, 16, terminating in rolled beads. The metal, which may include precious materials, such as gold, platinum, silver, and other known precious metals as well as non precious metals, is then shaped in the form of a bracelet as shown in FIG. 1. Thereafter, if desired, the exterior can be decorated aesthetically as shown by the decoration 18 formed on the exterior surface.

FIG. 3 shows another type of bracelet 20, again formed of sheet material. In this case, the sheet material is bent such that its cross-sectional shape, as shown in FIG. 4, is a rectangle. The exterior surface thereof, 22, is then decorated by means of holes 24 and the like or any other way as desired. However, in this case, the interior side, 26, which faces the wrist, is of solid sheet material.

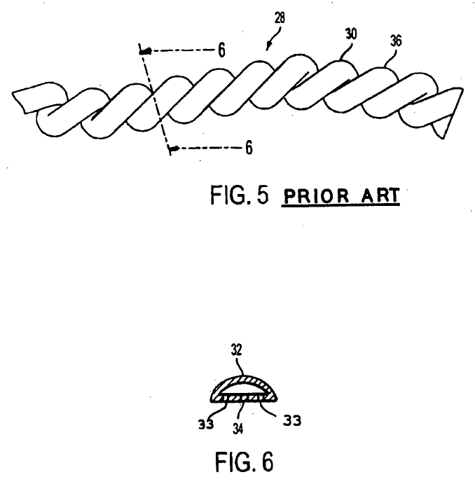

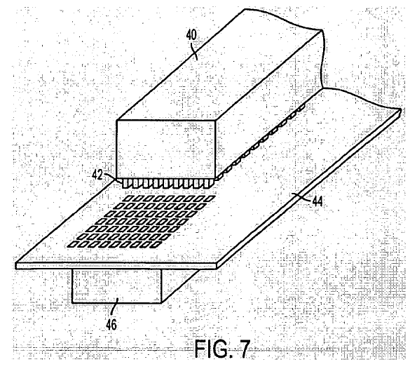

FIG. 5 shows a typical bracelet referred to as the San Marco bracelet 28. In this case, the bracelet is formed of individual arcuate rings 30, which are typically pivoted one to its adjacent ones in a well known fashion. Each of these rings 30 are shown in cross-section in FIG. 6 as having an arcuate exterior end 32 and a flat interior portion 34. Alternately the interior 34 might also be arcuate.

Here again, each of these rings 30, are made of flat sheet material which are solid and it is bent into the particular shape. Furthermore, again as desired, after the bracelet is formed, selected ones can be formed with aesthetic exteriors, as shown in 36 where the exterior is provided with a matte finish.

However, what is common to each of these articles of jewelry, as well as numerous others including, but not limited to, pins, earrings, necklaces and rings, is that they are all initially formed from flat solid sheet of precious material. That material is then bent, shaped, curved or in any way provided to the specific desired shape for utilization either as the jewelry article itself (bracelets) or in the formation of a ring, loop, or the like to be joined with others in the formation of another article of jewelry.

In accordance with the present invention, there is provided a sheet of material, instead of being solid is perforated. Such perforations can be made by means of a punching arrangement, as shown in FIG. 7. In such arrangement, there is provided an upper block 40 which has a plurality of pins 42 projecting downwardly there from. A sheet of solid precious material 44 is passed beneath the punch. A receiving punch 46 supports the precious solid metal material 44. As the metal is placed beneath the upper punch, the upper punch 40 is lowered, and each of the pins provides a perforation into the precious metal.

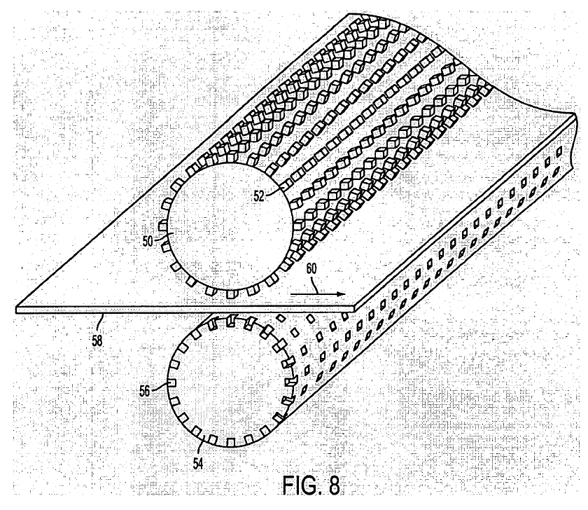

As an alternate method of producing the perforations there can be used a set of rollers as shown in FIG. 8. In such case, the upper roller 50 again has pins 52 projecting from its exterior. There is a receiving lower roller 54 which has receiving holes 56 for receiving each of the pins 52. The precious solid sheet material 58 passes in the direction of the arrow 60 as it moves between the rollers. The pins from the upper roller extend into the receiving holes of the lower roller and form the perforations into the solid material.

It should be appreciated that in the perforation arrangements of both FIGS. 7 and 8, the portion with the pins can be reversed as to be on the bottom. Furthermore, it should be appreciated that other well known techniques can be used instead of punching, rolling or forming such perforations into the sheet material. The objective, however, is to provide through such use of pins forming holes into the sheet material prior to the sheet material being utilized in the formation of the jewelry. The result of the inventive method is by way of example bracelet 12 of FIG. 2 having a pattern of perforations 13, or FIG. 4 having perforations 19, or FIG. 6 having perforations 33.

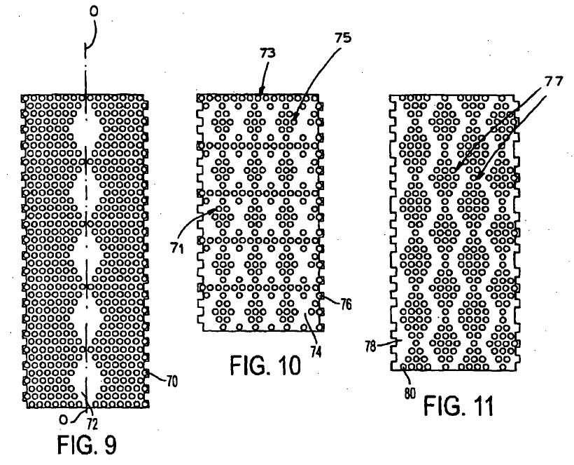

Numerous patterns can be formed. By way of example in FIG. 9 there is shown a pattern wherein uniform perforations are formed throughout the section as shown in portion 70. The entire sheet material can actually be formed this way. However, if additional designs are desired, then in certain portions shown at 72, some of the pins can be removed so that in those sections no perforations are formed and the solid metal will remain in a desired pattern. As shown in FIG. 9, the desired pattern is diamonds extending along a single common line between two spaced rows of perforations. The number of spaced rows of diamonds is unlimited, and the rows themselves may extend parallel or transversely to a longitudinal axis 0—0 of portion 70.

It should be appreciated that an almost infinite number of patterns can be formed throughout this. By way of example, in FIG. 10, there is provided a different pattern with solid portions 74, and perforations 76. The perforations 76 are arranged in spaced parallel columns 71, each of which has a plurality of arrays of holes 75. The arrays of holes 75 each has a generally diamond shape. The pattern of perforations further includes a plurality of spaced rows of perforations 73 extending transversely to the columns of perforations 71. The adjacent arrays of holes 75, which belong to respective neighboring columns 71, are aligned and define therebetween respective generally X-shaped portions of solid material 74.

FIG. 11 shows another pattern where spaced holes are arranged in parallel columns of perforated sections 80 spaced from one another so as to define respective solid portions or regions 78. Each column of perforated section 80 has a plurality of diamond-shaped arrays 77 extending along a common line. The arrays of holes 77 of each perforated section or column 80 are offset relative to respective arrays 77 of the adjacent perforated section 80 so as to form a zigzag line of solid portion 78 therebetween. Instead of diamond-shaped arrays 77, the oval-shaped or round-shaped arrays may be used to define a generally sinusoidal or wave-like line.

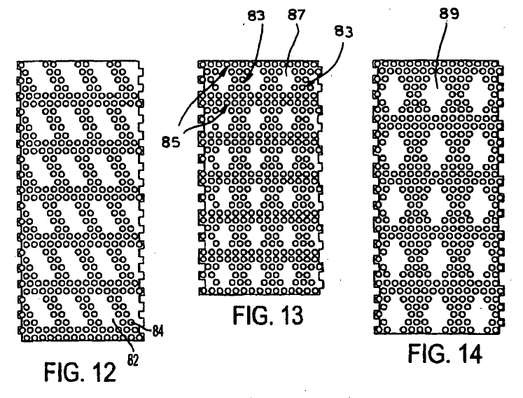

FIG. 12 shows yet a further design incorporating angled solid portions 82 with perforated angle sections 84. FIG. 13 shows use of multiple non-perforated diamond-shaped sections 87 defined between multiple spaced rows of perforations 85 and columns of perforations 83. Likewise FIG. 14 shows different perforations sizes and relationships between the diamond-shaped solid portions 89 and perforation arrays which are arranged in rows and columns extending transversely to one another. While FIGS. 9-14 each illustrate uniformly shaped and sized non-perforated regions or sections of the sheet of material, it is readily understood that these non-perforated regions may be nonuniformly configured by rearranging a pattern of pins in FIGS. 7 and 8.

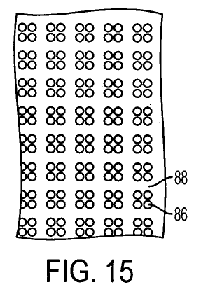

FIG. 15 shows a limited use of the perforations 86 with substantially more solid portion 88 giving the appearance more of a solid with a perforated design rather than a perforated plate with a solid section.

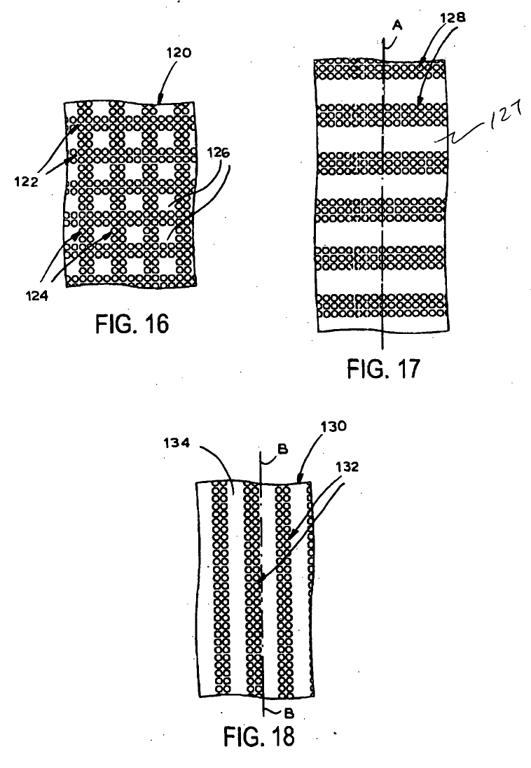

FIG. 16 illustrates a further pattern of perforations 120 arranged in spaced parallel rows 122 and columns 124 extending substantially perpendicular to one another. As a result, the section of the sheet of material or the entire sheet has a plurality of spaced non-perforated rectangularly-shaped regions 126.

FIG. 17 illustrate a plurality of spaced parallel rows of holes or perforations 128 extending substantially perpendicular to a longitudinal axis A—A of the sheet of material. The adjacent rows of perforations 128 define therebetween respective non-perforated elongated regions 127. As can be seen, the cumulative area of perforated regions of the sheet of material is substantially equal to the area of non-perforated regions.

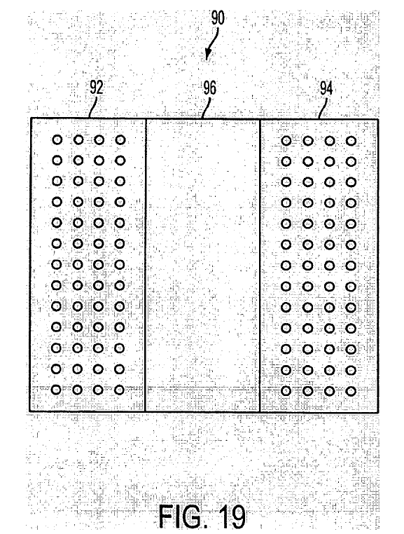

FIG. 18 illustrated still a further pattern of perforations 130 arranged in a plurality of spaced columns of holes 132 defining therebetween respective non-perforated regions 134. In contrast to FIG. 17, columns of holes 132 extend substantially parallel to a longitudinal axis B—B of the sheet of material.

It should be appreciated, that the shape of the perforation itself can be any shape desired simply by making the shape of the pins with the desired shape. Thus, it can be round, elongated, square, and oval or any other geometric or non geometric shape as desired. Furthermore, not all the pins have to be uniform, but some can be of one shape and size and some of another shape and size.

The solid sections are easily formed by simply eliminating the pins from those sections desired to be retained as solid. Similar to the perforations, the non-perforated or solid sections may have various shapes including various polygonal shapes, round shapes, oval shapes and other regular and irregular shapes.

Furthermore, the entire sheet of material need not be perforated throughout. As shown in FIG. 19, there is provided a sheet of material 90 having two side sections 92, 94 which do have perforations while the center section 96 remains solid and non-perforated.

The use of the various perforated materials can be in various ways. By way of example, making use of uniformly spaced and configured perforations 13 throughout an initial sheet of material can provide the bangle bracelet 10 of FIG. 1 with a pattern of perforations 13, as illustrated in FIG. 2. Alternately, making use of a perforated sheet having certain selected solid sections, as for example, FIG. 9, can provide the bangle bracelet with a diamond shape design along its exterior. In this matter, the design is actually formed before the material is made into the bangle bracelet. This avoids the need for the formation of the design after the bangle bracelet has been formed, as in the prior art.

Furthermore, the present invention can be used to form the bracelet in FIG. 3 in various ways. In one manner, the partitioned material shown in FIG. 19 is utilized. In this way, only the interior portions, not seen and those which face the wrist can be provided with a pattern of perforations 19, as schematically shown in FIG. 4. In this case, the use of the perforations is simply to reduce the weight of the metal. The solid metal can be used on the outside and thereafter can be designed or decorated as in the prior art. Similarly, rings 30 and 36 of San Marco bracelet 28 of FIG. 5 each can be provided with a pattern of perforations 33 selectively formed in one or more of the ring's interior and exterior sides, as shown in FIG. 6.

Of course, alternately, the entire portion can be perforated and the perforations used to provide the design in the exterior portion of the bracelet so that it can be preformed by means of the perforations even before the bracelet is formed.

Accordingly, it should be appreciated that the present use of the perforated metal can be either for cost saving purposes alone or for cost saving along with providing aesthetic appearances in a manner that is easier than has heretofore been achieved.

With respect to the cost saving, table 1 shows various calculations based upon a sheet of material having a fixed surface area and depending upon the size of a square hole formed. In the first column, if the size of the hole has a 0.4 mm side, then throughout the sheet there will be a savings of 53% of gold. On the other hand, if the hole size is larger, as for example 0.8 mm, there will be a much greater savings since again there will be less precious material and more gold.

Of course, this only demonstrates using a square hole. Other arrangements can be made and other saving arrangements depending upon the size, spacing and location of the holes will determine different savings.

By way of example, a typical space between holes can be 0.15 mm. The hole spaces can be center to center 0.13 mm. However, this can clearly vary based upon the size of the hole, the spacing desired, the amount of solid material desired, the shape, etc.

However, the thrust of the invention is that there is being utilized a perforated sheet of material to form numerous articles of jewelry where solid material has heretofore been utilized. This results in a cost savings and also facilitates formation of aesthetic appearances in the desired article of jewelry. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention.

What is claimed is:

1. A method of making an article of jewelry comprising:
forming a pattern of spaced perforations in at least a section of a sheet of material; and
shaping the sheet of material into the article of the jewelry so that at least one portion of the article of jewelry comprises the pattern of spaced perforations.

2. The method of claim 1, wherein the forming of the pattern of spaced perforations into the section of the sheet of material comprises:
removably mounting a plurality of pins to one of opposing surfaces of respective first and second punch blocks of a punching arrangement so as to selectively arrange the pins in a pin pattern corresponding to the pattern of spaced perforations, the other opposing surface having a plurality of holes aligned with and configured to receive respective pins,
placing the sheet of material between the first and second punch blocks, the sheet of material being flat; and
linearly displacing the first and second punch blocks relative to one another and transversely to the flat sheet of material to produce the pattern of spaced perforations into the section of the flat sheet.

3. The method of claim 1, wherein the forming of the pattern of spaced perforations into the section of the sheet of material comprises:
rotating two rolls relative to one another about respective parallel axes, a peripheral surface of one of the rolls having a plurality of removably mounted pins selectively arranged to define the pattern of perforations, a peripheral surface of the other roll having a plurality of holes configured to receive respective pins, and
simultaneously therewith passing the sheet of material between the two rolls to produce the pattern of spaced perforations into the at least one section of the sheet, the sheet of material being flat.

4. The method of claim 1, wherein the sheet of material is initially flat or uneven, the material comprising precious metals or non precious metals, the precious metals being one of gold, platinum and silver.

5. The method of claim 1, wherein the pattern of spaced perforations is formed throughout the sheet of material.

6. The method of claim 1, wherein the sheet of material has a plurality of sections selectively provided with the pattern of perforations.

7. The method of claim 1, wherein the pattern of perforations produced into the section of the sheet of material comprises a plurality of holes spaced uniformly or nonuniformly from one another, the plurality of holes being uniformly sized and shaped or nonuniformly sized and shaped and each having a shape selected from the group consisting of a polygonal shape, round shape, oval shape and a combination thereof.

8. The method of claim 1, wherein the pattern of spaced perforations comprises a plurality of spaced parallel rows of holes and spaced parallel columns of holes, the rows and columns of holes extending transversely to one another to define therebetween respective non-perforated regions of the section of the sheet of material, the non-perforated regions being uniformly configured or nonuniformly configured and each having a shape selected from the group consisting of a polygonal shape, circular shape, irregular geometric shape and a combination thereof.

9. The method of claim 1, wherein the pattern of spaced perforations comprises a plurality of holes arranged in spaced parallel rows, the spaced rows of holes defining therebetween one or more elongated non-perforated regions extending parallel to or transversely to a longitudinal axis of the sheet of material, the non-perforated regions each being zigzag shaped or having a series of aligned diamond-shaped portions.

10. The method of claim 1, wherein the pattern of spaced perforations is so configured that a perforated area of the section of the sheet of material is larger or smaller than or equal to an non-perforated area of the section of the sheet of material.

11. The method of claim 1, wherein the shaping of the sheet of material includes forming an individual ring, individual loop, bracelet, chain, ring, pin, earring or necklace.

12. The method of claim 1, wherein the article of jewelry has a periphery provided with a cross-sectional shape, the cross-sectional shape comprising an arcuate exterior side and a flat or arcuate interior side extending between opposite ends of the arcuate exterior side and configured to extend next to a body part of a wearer, the exterior side or the interior side or both the exterior and interior sides having the pattern of spaced perforations, the interior side being continuous or discontinuous.

13. The method of claim 1, wherein the article of jewelry or the part thereof has a periphery provided with a polygonal cross-sectional shape, the polygonal cross-sectional shape including an interior side configured to extend next to a body part of a wearer, at least one top exterior side spaced from the interior side, and at least two spaced lateral exterior sides extending between the interior and at least one top exterior sides, one or more of the interior and exterior sides having the pattern of the spaced perforations.

14. The method of claims 11, further comprising shaping at least one additional ring or loop and joining a plurality of individual rings or loops to one another so that two or more consecutive joined rings or loops are twisted relative to one another to form a San Marco bracelet or an Omega chain.

15. An article of jewelry comprising a body having at least one region thereof provided with a pattern of spaced perforations, the body being configured from a sheet of material having at least one section thereof provided with the pattern of spaced perforations prior to shaping the sheet of material into the article of jewelry.

16. The article of jewelry of claim 15, wherein the body has a periphery provided with a cross-sectional shape, the cross-sectional shape having an arcuate exterior side and an interior side extending between opposite ends of the arcuate side and configured to extend next to a body part of a wearer.

17. The article of jewelry of claim 16, wherein the interior side of the periphery is flat or arcuate and extends continuously or discontinuously between the opposite ends of the arcuate exterior side, the interior side having the at least one or more regions with the pattern of spaced perforations providing the article of jewelry with a reduced weight.

18. The article of jewelry of claim 16, wherein the arcuate exterior side of the periphery is decorated with the pattern of spaced perforations.

19. The article of jewelry of claim 16, wherein the exterior and interior sides of the periphery each have the at least one or more regions provided with the pattern of spaced perforations.

20. The article of jewelry of claim 15, wherein the body has a periphery provided with a polygonal cross-sectional shape, the polygonal cross-sectional shape having a plurality of adjacent exterior sides and an interior side, the interior side being configured to extend between the exterior sides next to a body part of a wearer.

21. The article of jewelry of claim 20, wherein the exterior and interior sides each have the pattern of spaced perforations.

22. The article of jewelry of claim 20, wherein the interior side has the pattern of spaced perforations.

23. The article of jewelry of claim 20, wherein one or more of the exterior sides have the pattern of spaced perforations.

24. The article of jewelry of claim 15, wherein the pattern of spaced perforations comprises a plurality of holes arranged in spaced parallel rows and spaced parallel columns, the rows and columns of holes traversing one another so as to define therebetween one or more non-perforated regions of solid material, the non-perforated regions of solid material being uniformly configured or nonuniformly configured and each having a shape comprising one of a polygonal shape, oval shape, round shape and irregular geometrical shape.

25. The article of jewelry of claim 15, wherein the pattern of spaced perforations comprises a plurality of holes arranged in spaced parallel rows in the at least one or more sections of the sheet of material, the spaced parallel rows of hole extending generally parallel to or transversely to a longitudinal axis of the sheet of material and defining therebetween respective non-perforated regions of solid material, the non-perforated regions of solid material each having a rectangular shape or a zigzag shape.

26. The article of jewelry of claim 15, wherein the pattern of spaced perforations includes a plurality of holes, the holes being uniformly shaped and dimensioned or non-uniformly shaped and dimensioned.

27. The article of jewelry of claim 15, wherein the sheet of material is shaped in a form of a bracelet, chain, ring, or pin.

28. The article of jewelry of claim 27, wherein the bracelet is selected from the group consisting of a bangle bracelet and a San Marco-type bracelet.

29. The article of jewelry of claim 15, wherein the sheet of initial material is flat or uneven and comprises precious metals or non precious metals.

30. The article of jewelry of claim 15, wherein the sheet of material is shaped in a form of a loop or ring, a plurality of loops or rings being joined together to form the article of jewelry comprising a San Marco-type bracelet or an Omega-type chain, wherein joined adjacent loops or rings being skewed relative to one another.
